(19) United States
(12) Patent Application Publication
(10) Pub. No.: US 2007/0083812 A1
(43) Pub. Date: Apr. 12, 2007

(54) GUI with improved mnemonic control

(76) Inventors: Thomas Randall Hudson JR., Cary, NC (US); Silenio Sulivan Quarti, Kanata (CA)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/246,415

(22) Filed: Oct. 7, 2005

(51) Int. Cl. G06F 3/00

(52) U.S. Cl. 715/700

(57) ABSTRACT

A system, method and computer program product are provided for controlling the operation of mnemonics so that mnemonics that are not in the user's notion of the active context (i.e., mnemonics that are not in the active pane in which the user is currently working) are blocked from operation. When an attempt is made to invoke a mnemonic, a determination is made as to whether or not the requested mnemonic is located within an inactive pane in the GUI. If the requested mnemonic is within an inactive pane, then the mnemonic request is blocked. If the requested mnemonic is somewhere other than in an inactive pane, then the attempt to invoke the mnemonic is allowed to succeed. The above-described control operations “follow” the active pane, so that if a user switches the active pane, these control functions operate in the newly-designated active pane.

### BACKGROUND OF THE INVENTION

1. Field of the Invention

The present invention is directed generally to graphical user interfaces (GUIs). More specifically, the present invention is directed to a method and apparatus for improving the usability of mnemonics in larger and/or extensible applications in which GUI components are contributed from multiple sources.

2. Description of the Related Art

A mnemonic is a feature in computer user interfaces that allows a user to directly access a control in the interfaces by pressing on a special key (usually the “alt” key) while simultaneously pressing a character. The mnemonic is usually an underscored character in a text label that is associated with the control. A control is a GUI element in the operating system, which may support keyboard focus. Examples include buttons and labels. A composite is a control that contains child controls, such as a pane, dialog, group box, and the like. A mnemonic allows a user to interact with an application program without using a pointing device (e.g., a mouse). Thus, mnemonics act as shortcuts to functions in application programs. Mnemonics can be found on menus and any control that accepts keyboard focus, such as a button or checkbox. Mnemonics can also be placed on controls that label another control. Invoking the label's mnemonic assigns keyboard focus to the labeled control.

Assigning mnemonics when developing a graphical user interface (GUI) can be a laborious task. For example, when doing so, a software developer has to be aware of all standard mnemonic character assignments, numerous assignment rules as well as checking for duplicate assignment of characters. Oftentimes, the scope of a set of mnemonic character assignments is limited to a particular region of the user interface. That is, a mnemonic character should be unique within a pane, dialog box, or a given level of a menu. However, when an extensible application contains GUI components contributed from multiple sources, the contributor of one component has no way of knowing which mnemonics are going to be used by other contributors, which means that there may be conflicting (e.g., identical) mnemonics displayed within a single GUI. Since many text labels are common to many dialog boxes in an application program, it is usually desirable to have mnemonic assignment to these common labels be as consistent as possible (i.e., to have them be the same across the different dialog boxes or menus).

As used herein the term “window” refers generically to any defined display area of a GUI; a “main GUI window” is the primary window in which one or more sub-windows are displayed; and a “pane” is a sub-window displayed within the main GUI window and which may contain independent controls. Frequently GUI's consist of multiple panes within the main GUI window, and a pane may itself contain multiple sub-panes. A pane and its controls loosely define a “context” in which the user is working. The particular pane that is the focus of the user's attention (i.e., the pane in which a user is actively working) is referred to as the active pane, and it defines the current context of the application.

When a pane is the active pane, various actions are controlled so that the active pane has almost exclusive control over many aspects of the GUI. For example, actions from the “edit” control in the menu bar such as “Undo”, “Copy”, and “Paste” are each mapped to the active pane's definition for those actions so that, for example, a “paste” action will paste clipped content into the active pane. Further, the active pane may have exclusive control of the status bar (e.g., only parameters associated with the active pane will be displayed in the status bar), and keybindings (e.g., the control functions bound to particular keys when depressed in connection with the CTRL button) defined by the active pane will typically active.

Mnemonics, however, are active across all panes in the GUIs of the prior art. This can cause several problems for the user, since as described above, extensible applications may have multiple panes with the same mnemonic defined for the same or different functions. For example, two different panes may each have the control Add, both controls using the same mnemonic A. Similarly, one pane may have the control Remove and another pane may have the control Erase, each with the mnemonic E. In situations such as these, the operating system will not handle the mnemonic properly, e.g., one of the mnemonics will be arbitrarily selected to be invoked. This is confusing for the user and prohibits optimal functionality, and it does not meet the Section 508 accessability guidelines of the U.S. Government.

This “active across all panes” characteristic of mnemonics can also cause problems when a user wishes to access a menu bar control. For example, if there is a first pane with the control Remove (using the mnemonic e), and a user working in a second pane (i.e., the second pane is the active pane) invokes the E mnemonic in an attempt to invoke the “Edit” menu selection from the menu bar, the expectation is that the edit menu will drop down. Instead, since the mnemonics are active across all panes, and the first pane has an available e mnemonic, the first pane becomes the active pane (the focus traverses from the second pane to the first pane), moving the user out of the pane in which they wish to be working, and the Remove control is invoked rather than the Edit menu from the menu bar. This behavior goes against the user's conceptualization of working in the context of the active pane.

Thus, what is needed is an apparatus and method of controlling the operation of mnemonics so that mnemonics in panes other than the active pane are disregarded, thus preserving the users notion of working in the context of a pane, and better supporting keyboard accessibility.

### SUMMARY OF THE INVENTION

A system, method and computer program product are provided for controlling the operation of mnemonics so that mnemonics that are not in the user's notion of the active context (i.e., mnemonics that are not in the active pane in which the user is currently working) are blocked from operation. In accordance with the present invention, when an attempt is made to invoke a mnemonic, a determination is made as to whether or not the requested mnemonic is located within an inactive pane in the GUI. If the requested mnemonic is within an inactive pane, then the mnemonic request is blocked. If the requested mnemonic is somewhere other than in an inactive pane, then the attempt to invoke the mnemonic is allowed to succeed. The above-described control operations “follow” the active pane, so that if a user switches the active pane, these control functions operate in the newly-designated active pane.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a simulated screen capture of a GUI display; and

FIG. 2 is a flowchart illustrating an embodiment of the present invention.

### DETAILED DESCRIPTION OF THE PREFERRED EMBODIMENTS

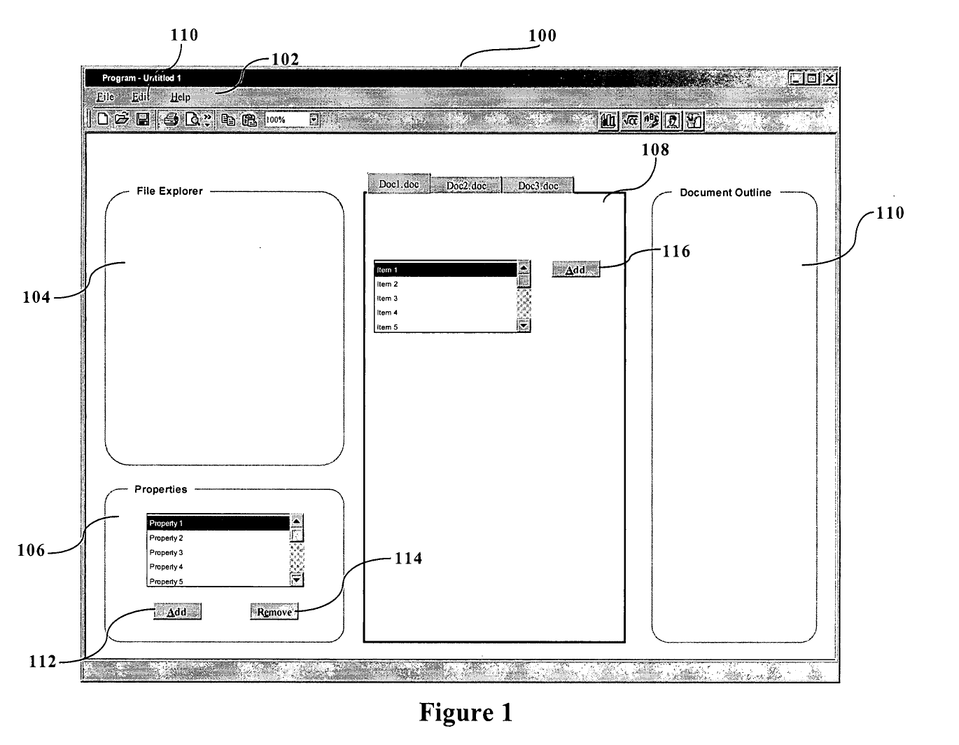

FIG. 1 is a simulated screen capture of a GUI display. The GUI 100 includes a menu bar 102 and multiple panes 104, 106, 108, and 110. Menu bar 102 includes multiple menu controls, e.g., “Edit” control 110. In this example, pane 106 includes “Add” control 112 and “Remove” control 114. Pane 108 also includes an “Add” control 116.

As can be seen in FIG. 1, each of the controls 110, 112, 114, and 116 include text identifying their function, and the text includes an underlined character identifying a keyboard control that can be utilized to invoke the control function. More specifically, Edit control 110 includes the text “Edit”; Add control 112 includes the text “Add”; Remove control 114 includes the text “Remove” and Add control 116 includes the text “Add”. The underlined characters displayed on controls 112, 114, and 116 are mnemonics. The underlined character displayed on control 110 is a lower-priority mnemonic that so that in the event of duplicate mnemonics (one in the active pane and the same letter in the menu line such as Edit control 110), the mnemonic in the active pane will take priority.

In FIG. 1, pane 108 is currently the active pane because a control belonging to that pane is the focus control, a known concept defined and supported by prior art windowing systems. In FIG. 1, pane 108 is identified as the active pane by the darkened border of the pane, in contrast to the other panes, which have gray borders.

In a well known manner, a user would typically invoke the mnemonic to activate the control identified on the control associated with the mnemonic. For the purpose of this example, it is assumed that the mnemonic is invoked by the simultaneous depressing of the “Alt” key and the mnemonic character contained in the text of the control. Thus, for example, a user wishing to invoke the control 116 to activate the Add control in pane 108 would typically hold down the Alt key and press, simultaneously, the “a” character on the keyboard.

The above invoking process functions fine as long as no conflicts exist between mnemonics displayed in the GUI, or between a mnemonic and a keyboard shortcut for an item in a menu bar. However, as can be seen in FIG. 1, conflicts do exist, and in the prior art there is no system in place for managing the operation of the mnemonics when such conflicts exist.

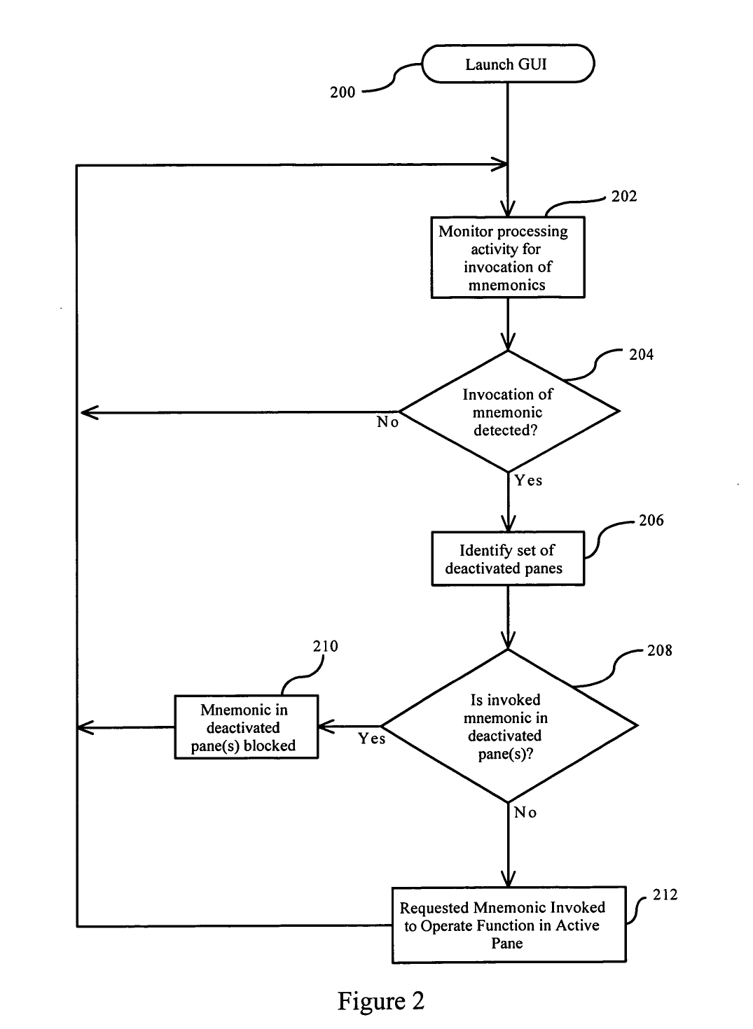

FIG. 2 is a flowchart illustrating an embodiment of the present invention which solves the above problem. In accordance with the present invention, the GUI is configured to perform the steps illustrated in FIG. 2 in connection with the functioning of mnemonic controls. Referring to FIG. 2, at step 200, the GUI is launched, and at step 202, the GUI monitors processing activity looking for the invocation of a mnemonic. At step 204, a determination is made as to whether or not an attempt to invoke a mnemonic has been detected. If no attempt to invoke a mnemonic has been detected, the process proceeds directly back to step 202 to continue monitoring processor activation for the invocation of mnemonics.

If, however, at step 204, the invocation of a mnemonic is detected, the process proceeds to step 206, where the panes in the GUI are scanned and a set of deactivated panes (those that are not active panes) is identified. The process then proceeds to step 208, where it is determined if the invoked mnemonic is located within a pane that has been designated as deactivated. Determining if a mnemonic belongs to a deactivated pane can be accomplished using known methods. For example, a simple algorithm can be executed to start with the Control that received the mnemonic and “walk up” its parent chain to see if it or any of its parents are members of the set of deactivated panes. Since the system knows which pane is the active pane, it can be assumed that all other panes are not the active pane, i.e., they are “deactivated.” The present invention goes through the mnemonics in the panes other than the active pane, and if at step 208 it is determined that the invoked mnemonic would activate a control within a pane that is not the active pane, that mnemonic is disregarded with respect to functions in the deactivated pane(s) (step 210). The process then proceeds back to step 214 and proceeds as described above.

If, at step 208, it is determined that the requested mnemonic is not within a deactivated pane, the process proceeds to step 212 where the requested mnemonic is invoked to operate the function with which it is associated. The process then proceeds back to step 214 and proceeds as described above.

In the examples described above, the deactivated panes are tracked and thus all panes that are not deactivated are active panes. It is understood, however, that the GUI can instead be configured to directly track the active pane(s). Further, it is understood that situations may arise where multiple panes may be active, e.g., where a pane has sub-panes and one of the sub-panes is active along with its parent pane while the other sub-panes are not active. The claims of the present invention cover these variations.

The following example is pseudo-code which may be invoked for every GUI element when a mnemonic character is detected. In this example, the GUI consists of a) a hierarchy of controls, where controls which contain other controls are referred to as composites; b) some of the composites represent panes; c) each control may have a mnemonic character assigned to it; d) a focus control (an OS concept that determines which control has active keyboard focus; and e) an active pane (the pane containing the focus control).

While focus control is an OS concept, a pane is not an OS concept. A pane is a visual grouping of one or more controls that is rendered as a group. It is often a composite with a border of some kind, and it may comprise multiple composites. The user expects that only mnemonics in the active pane are enabled. A purpose of the present invention is to simulate pane support. When the user invokes a mnemonic, the OS sends a traversal event which indicates that the focus control may be changing due to the invoking of the mnemonic.

Traversal events enable an application to override normal OS behavior. When a traversal event triggers (which is a known function of the particular windowing system, programming language, and library being used), then the control will gain focus. If the traversal event does not trigger, this prevents the control from gaining focus.

Thus, the present invention can be embodied by the following pseudo-code, which will be invoked for every GUI element when a mnemonic character is detected. It is possible to have this procedure invoked by adding an event filter to the GUI application, which will receive all events of a specific type from anywhere within the GUI. The pseudo-code that follows will be understandable to one of ordinary skill in the art and is given for purpose of example only:

```
/*
  * As traversal events are filtered going to each GUI control, this
  method determines if that control should be allowed
to obtain focus
*/
boolean allowMnemonicTraversal (Composite context, Control candidate,
boolean input) {
```

```
  // If the candidate is not going to receive focus according to
// default OS rules, don't change anything
  if (input = = false)
```

Return false;

```
  // Otherwise, the candidate is going to receive focus. Verify
// that it is contained in the active context
  while (candidate !=null) {
```

if (context = =candidate)

Return true;

candidate = candidate.getParent( );

```
  }
  // The focus candidate is not contained inside the active context
  return false;
```

}

If the GUI contains the notion of “nested contexts,” then it is possible for more than one context to be active. For example, if a “child” context is nested within one or more “parent” contexts, the context, and any context in which it is contained, should be active. The present invention can be extended to support nested contexts as follows:

boolean allowMnemonicTraversal (Set deactivedControls, Control
candidate, boolean input) {

```
  // If the candidate is not going to receive focus according
// to default OS rules, don't change anything
  if (input= =false)
```

Return false;

```
  // Otherwise, the candidate is going to receive focus.
// See if it belongs to a deactivated control
  while (candidate !=null) {
```

if (deactivedControls.Contains(candidate))

Return false;

candidate=candidate.getParent( );

```
  }
  // The focus candidate is not contained inside an inactive pane,
// so it must be in an active pane
  return true;
```

}

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a workstation on which the GUI is running. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-2 support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art and it is intended that the present invention encompass such changes and modifications as fall within the scope of the appended claims. For example, while the above examples describe simply the deactivation of mnemonics when they are in deactivated panes, an alternative is to toggle off the display of the mnemonic in deactivated panes, so that a user will not even see the mnemonic displayed unless the mnemonic is available to be used. This an example of a modification that falls within the scope of the appended claims.

We claim:

1. A system for supporting the operation of mnemonics within panes displayable on a graphical user interface (GUI), said system comprising:
a processor, a display, and a memory system, wherein said display and said memory system are all coupled to said processor and wherein said GUI is displayed on said display; and
program code within said memory system and executable by said processor to cause said processor to identify panes of said GUI displayed within said display that are not active panes, and to block attempts to invoke mnemonics in any panes identified as not being active.

2. The system of claim 1, wherein attempts to invoke mnemonics in panes other than those that have been identified as not being active are allowed to succeed.

3. The system of claim 2, wherein said program code continuously monitors the active/inactive status of panes in said GUI and if a pane changes to inactive status, attempts to invoke mnemonics within said pane are blocked.

4. The system of claim 3, wherein if a pane changes out of inactive status, attempts to invoke mnemonics within said pane are allowed to succeed.

5. The system of claim 4, wherein said program code causes said processor to identify an active pane displayed in said GUI and to allow attempts to invoke mnemonics in said active pane to succeed.

6. The system of claim 5, wherein said active pane includes one or more sub-panes within said active pane, and wherein attempts to invoke mnemonics within said one or more sub-panes are allowed to succeed.

7. A processor-implemented method for supporting the operation of mnemonics within panes displayable on a display in a graphical user interface (GUI), comprising:
identifying, using said processor, panes of said GUI displayed within said display that are not active panes; and
blocking, using said processor, attempts to invoke mnemonics in any panes identified as not being active.

8. The method of claim 7, wherein attempts to invoke mnemonics in panes other than those that have been identified as not being active are allowed to succeed.

9. The method of claim 8, further comprising:
continuously monitoring the active/inactive status of panes in said GUI, whereby if a pane changes to inactive status, attempts to invoke mnemonics within said pane are blocked.

10. The method of claim 9, wherein if a pane changes out of inactive status, attempts to invoke mnemonics within said pane are allowed to succeed.

11. The method of claim 10, further comprising:
identifying an active pane displayed in said GUI; and
allowing attempts to invoke mnemonics in said active pane to succeed.

12. The method of claim 11, wherein said active pane includes one or more sub-panes within said active pane, and wherein attempts to invoke mnemonics within said one or more sub-panes are allowed to succeed.

13. A computer program product for supporting the operation of mnemonics within panes displayable on a display in a graphical user interface (GUI), said computer program product comprising:
program code executable by a data processing system to identify panes of said GUI displayed within said display that are not active panes; and
program code executable by said data processing system to block attempts to invoke mnemonics in any panes identified as not being active.

14. The computer program product of claim 13, further comprising:
program code executable by said processor to allow the invocation of mnemonics in panes other than those that have been identified as not being active to succeed.

15. The computer program product of claim 14, further comprising:
program code executable by said processor for continuously monitoring the active/inactive status of panes in said GUI, whereby if a pane changes to inactive status, attempts to invoke mnemonics within said pane are blocked.

16. The computer program product of claim 15, further comprising:
program code executable on said processor to allow attempts to invoke mnemonics within said pane to succeed if a pane changes out of inactive status.

17. The computer program product of claim 16, further comprising:
program code executable on said processor to identify an active pane displayed in said GUI; and
program code executable on said processor to allow attempts to invoke mnemonics in said active pane to succeed.

18. The computer program product of claim 17, wherein said active pane includes one or more sub-panes within said active pane, and wherein attempts to invoke mnemonics within said one or more sub-panes are allowed to succeed.
